(19) United States
(12) Patent Application Publication
(10) Pub. No.: US 2025/0211336 A1
(43) Pub. Date: Jun. 26, 2025

(54) APPARATUS AND METHOD FOR DETERMINING SIGNAL CORRELATION

(71) Applicant: Fujitsu Limited, Kawasaki-shi (JP)

(72) Inventors: Tong YE, Beijing (CN); Zhenning TAO, Beijing (CN); Xiaofei SU, Beijing (CN)

(73) Assignee: Fujitsu Limited, Kawasaki-shi (JP)

(21) Appl. No.: 18/975,184

(22) Filed: Dec. 10, 2024

(30) Foreign Application Priority Data
Dec. 22, 2023 (CN) 202311785137.8

(51) Int. Cl. H04B 10/556; H04B 1/7075; H04B 10/50; H04B 10/54

(52) U.S. Cl. CPC H04B 10/5561; H04B 1/7075; H04B 10/5053; H04B 10/541

(57) ABSTRACT

An apparatus and a method for determining signal correlation, the method including: inputting a first signal to a first electro-optical conversion unit, to enable the first electro-optical conversion unit to modulate to-be-modulated light according to the input first signal and to obtain a to-be-measured signal; inputting a second signal to a second electro-optical conversion unit, to enable the second electro-optical conversion unit to modulate to-be-modulated light according to the input second signal and to obtain a correlation signal; determining a product signal of the to-be-measured signal and the correlation signal via a photoelectric method or an optical method; and determining correlation of the to-be-measured signal and the correlation signal by performing an electrical average operation on the product signal. Therefore, correlation of two high-speed signals is obtained by only using a low-bandwidth electrical device without requiring use of a large-bandwidth multiplier.

### CROSS-REFERENCE TO RELATED APPLICATIONS

This application is based on and hereby claims priority to Chinese Application No. 202311785137.8, filed Dec. 22, 2023, in the China National Intellectual Property Administration, the disclosure of which is incorporated herein by reference.

### TECHNICAL FIELD

Embodiments of the present disclosure relate to the field of optical communication technology.

### BACKGROUND

In the field of optical communication, in order to achieve a greater communication capacity, a signal rate output by a transmitter is very high, such as 100G bauds. These signals typically include a plurality of sub-signals. For example, a dual-polarization system has two polarization components, i.e., x and y; a coherence system has an in-phase component I and a quadrature component Q; under a DAC architecture, PAM8 is a superposition of three 0/1 sequences, and each 0/1 sequence constitutes a sub-signal. Under modulation by a multi-modulation unit (multi-segment), a total signal is a superposition of signals of each modulation unit (segment), and a sub-signal is formed on each modulation unit. These sub-signals are typically generated by different electrical and optical components, and if their analog characteristic has a bias, the performance of a high-speed optical transmitter is reduced. Therefore, monitoring the characteristics of high-speed signals and sub-signals is a necessary function of a high-speed transmitter. Currently, acquisition of correlation is a basic method for monitoring a high-speed signal/sub-signal characteristic.

It should be noted that the above introduction to the technical background is just to facilitate a clear and complete description of the technical solutions of the present disclosure, and is elaborated to facilitate the understanding of persons skilled in the art, it cannot be considered that these technical solutions are known by persons skilled in the art just because these solutions are elaborated in the Background of the present disclosure.

### SUMMARY

According to one aspect of the embodiments of the present disclosure, an apparatus for determining signal correlation is provided.

The apparatus may include a memory; and a processor coupled to the memory to: input a first signal to a first electro-optical conversion unit, to enable the first electro-optical conversion unit to modulate to-be-modulated light according to the input first signal and to obtain a to-be-measured signal; input a second signal to a second electro-optical conversion unit, to enable the second electro-optical conversion unit to modulate to-be-modulated light according to the input second signal and to obtain a correlation signal; determine a product signal of the to-be-measured signal and the correlation signal via a photoelectric method or an optical method; and determine correlation of the to-be-measured signal and the correlation signal by performing an electrical average operation on the product signal.

According to one aspect of the embodiments of the present disclosure, a method for determining signal correlation is provided. The method may include inputting a first signal to a first electro-optical conversion unit, to enable the first electro-optical conversion unit to modulate to-be-modulated light according to the input first signal and to obtain a to-be-measured signal; inputting a second signal to a second electro-optical conversion unit, to enable the second electro-optical conversion unit to modulate to-be-modulated light according to the input second signal and to obtain a correlation signal; determining a product signal of the to-be-measured signal and the correlation signal via a photoelectric method or an optical method; and determining correlation of the to-be-measured signal and the correlation signal by performing an electrical average operation on the product signal.

Referring to the later description and drawings, specific implementations of the embodiments of the present disclosure are disclosed in detail, indicating a manner that the principle of the embodiments of the present disclosure may be adopted. It should be understood that the implementations of the present disclosure are not limited in terms of a scope. Within the scope of the spirit and terms of the attached claims, the implementations of the present disclosure include many changes, modifications and equivalents.

### BRIEF DESCRIPTION OF DRAWINGS

The included drawings are used to provide a further understanding on the embodiments of the present disclosure, constitute a part of the Specification, are used to illustrate the implementations of the present disclosure, and expound the principle of the present disclosure together with the text description. Obviously, the drawings in the following description are only some embodiments of the present disclosure. Persons skilled in the art may further obtain other implementations based on these drawings under the premise that they do not pay inventive labor. In the drawings:

FIG. 1 is a schematic diagram of a method for determining signal correlation according to an embodiment of the present disclosure;

FIGS. 2A, 2B, 2C, 2D to FIG. 2E are schematic diagrams of a first electro-optical conversion unit according to an embodiment of the present disclosure;

FIGS. 3A, 3B, 3C, 3D to FIG. 3E are schematic diagrams of a second electro-optical conversion unit according to an embodiment of the present disclosure;

FIGS. 4A, 4B, 4C to FIG. 4D are schematic diagrams of a photoelectric multiplier according to an embodiment of the present disclosure;

FIGS. 5A, 5B to FIG. 5C are schematic diagrams of an electrical average unit according to an embodiment of the present disclosure;

FIG. 6 is a schematic diagram of a method for determining signal correlation by using a photoelectric method according to an embodiment of the present disclosure;

FIGS. 7, 8, 9 to FIG. 10 are schematic diagrams of a hardware structure for implementation of the method shown in FIG. 6, according to an embodiment of the present disclosure;

FIG. 11 is a schematic diagram of a method for determining signal correlation by using an optical method according to an embodiment of the present disclosure;

FIGS. 12, 13 to FIG. 14 are schematic diagrams of a hardware structure for implementation of the method shown in FIG. 11, according to an embodiment of the present disclosure;

FIG. 15 is another schematic diagram of a method for determining signal correlation according to an embodiment of the present disclosure;

FIG. 16 is a partial schematic diagram of a hardware structure for implementation of the method shown in FIG. 15, according to an embodiment of the present disclosure;

FIG. 17 is a schematic diagram of an apparatus for determining signal correlation according to an embodiment of the present disclosure; and

FIG. 18 is a schematic diagram of an electronic device according to an embodiment of the present disclosure.

### DETAILED DESCRIPTION

Referring to the drawings, through the following Specification, the above and other features of the embodiments of the present disclosure will become obvious. The Specification and the figures specifically disclose particular implementations of the present disclosure, showing partial implementations which may adopt the principle of the embodiments of the present disclosure. It should be understood that the present disclosure is not limited to the described implementations, on the contrary, the embodiments of the present disclosure include all the modifications, variations and equivalents falling within the scope of the attached claims.

In the embodiments of the present disclosure, the term “first” and “second”, etc. are used to distinguish different elements in terms of appellation, but do not represent a spatial arrangement or time sequence, etc. of these elements, and these elements should not be limited by these terms. The term “and/or” includes any and all combinations of one or more of the associated listed terms. The terms “include”, “comprise” and “have”, etc. refer to the presence of stated features, elements, members or components, but do not preclude the presence or addition of one or more other features, elements, members or components.

In the embodiments of the present disclosure, the singular forms “a/an” and “the”, etc. include plural forms, and should be understood broadly as “a kind of” or “a type of”, but are not defined as the meaning of “one”; in addition, the term “the” should be understood to include both the singular forms and the plural forms, unless the context clearly indicates otherwise. In addition, the term “according to” should be understood as “at least partially according to . . . ”, the term “based on” should be understood as “at least partially based on . . . ”, unless the context clearly indicates otherwise.

Features that are described and/or illustrated with respect to one implementation may be used in the same way or in a similar way in one or more other implementations and in combination with or instead of the features in the other implementations. The term “comprise/include” when being used herein refers to the presence of a feature, a whole piece, a step (operation) or a component, but does not exclude the presence or addition of one or more other features, whole pieces, steps or components.

The inventor finds that in order to facilitate applying and processing of a monitored high-speed signal/sub-signal, a last monitored signal still needs to be converted to an electrical signal so as to use a signal processing algorithm. A basic unit of a relevant operation includes two parts, i.e., a multiplication operation and an average operation. However, because a transmitter output signal speed is very high, such as 100G bauds, it is very difficult to obtain correlation of two high-speed signals, especially direct implementation of a signal multiplier with dozens of GHz bandwidths is very difficult.

For at least one of the above technical problems, the embodiments of the present disclosure provide an apparatus and a method for determining signal correlation. With the help of electro-optic, photoelectric, optics, electricity and other technologies to obtain correlation of two high-speed signals, an implementation mode is flexible, and there are many application scenarios.

One of advantageous effects of the embodiments of the present disclosure includes: correlation of two high-speed signals may be obtained by only using a low-bandwidth electrical device without requiring use of a large-bandwidth multiplier; an implementation mode is flexible, it may be implemented in an integrated or non-integrated manner; application scenarios are rich, and suitable for characteristic monitoring of high-speed signals/sub-signals in a variety of transmitters.

### Embodiments of a First Aspect

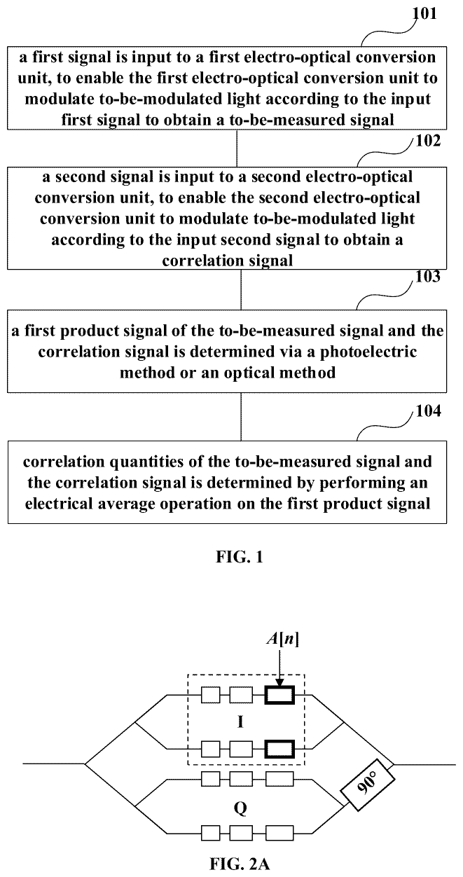

Embodiments of the present disclosure provide a method for determining signal correlation. FIG. 1 is a schematic diagram of a method for determining signal correlation in the embodiments of the present disclosure.

As shown in FIG. 1, the method includes:
operation 101, a first signal is input to a first electro-optical conversion unit, to enable the first electro-optical conversion unit to modulate to-be-modulated light according to the input first signal and to obtain a to-be-measured signal;
operation 102, a second signal is input to a second electro-optical conversion unit, to enable the second electro-optical conversion unit to modulate to-be-modulated light according to the input second signal and to obtain a correlation signal;
operation 103, a first product signal of the to-be-measured signal and the correlation signal is determined via a photoelectric method or an optical method; and
operation 104, correlation of the to-be-measured signal and the correlation signal is determined by performing an electrical average operation on the first product signal.

It should be noted that the above FIG. 1 only schematically describes the embodiments of the present disclosure, but the present disclosure is not limited to this. For example, some of the above steps may be performed simultaneously or in a sequential order, an execution step of each operation may be adjusted appropriately, moreover other some operations may be increased or reduced. Persons skilled in the art may make appropriate modifications according to the above contents, not limited to the records in the above FIG. 1.

In some embodiments, in operation 101, the first signal is a symbol sequence of the first electro-optical conversion unit, which is referred to as a first symbol sequence A[n] in the present disclosure. The first electro-optical conversion unit modulates to-be-modulated light input thereto according to the first symbol sequence A[n], to obtain a to-be-measured signal, the to-be-measured signal is a high-speed signal and an optical signal. The to-be-modulated light e.g., is direct current light, or an optical signal output by an upper level unit connected to the first electro-optical conversion unit.

In some embodiments, the first electro-optical conversion unit is a unit with a modulation function and being capable of generating a high-speed signal. For example, the first electro-optical conversion unit is a transmitter per se, or a partial modulation unit of the transmitter. For example, the transmitter includes but is not limited to a coherence transmitter, an intensity modulation transmitter, a directly modulated laser, a phase modulator, an optical frequency comb-based combination signal transmitter.

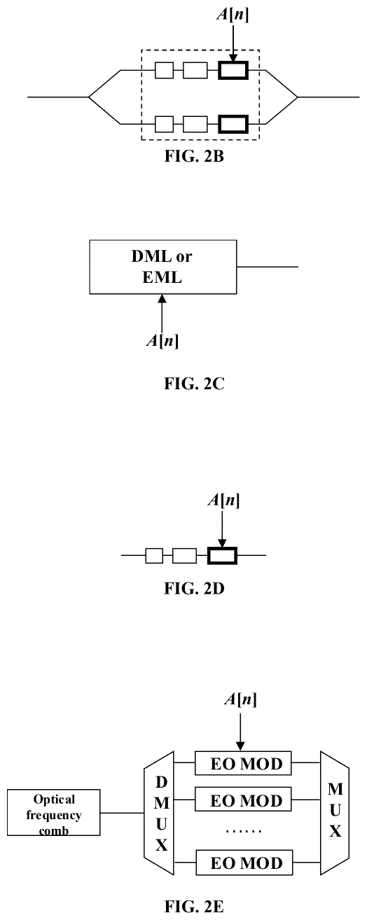

FIGS. 2A, 2B, 2C, 2D to FIG. 2E are schematic diagrams of a first electro-optical conversion unit in the embodiments of the present disclosure. FIG. 2A shows an IQ modulator with a plurality of sub-signal branches in a coherence transmitter, both I channel and Q channel of the IQ modulator have a plurality of modulation units. The first electro-optical conversion unit in FIG. 2A may be any one modulation unit in the IQ modulator, such as a modulation unit corresponding to the first symbol sequence A[n] on the I channel, that is, a modulation unit into which the first symbol sequence A[n] is input. In FIG. 2B, the first electro-optical conversion unit is a modulation unit corresponding to the first symbol sequence A[n] in a segmented intensity modulator. In FIG. 2C, the first electro-optical conversion unit is a Directly Modulated Laser (DML) or an External Modulated Laser (EML). In FIG. 2D, the first electro-optical conversion unit is a modulation unit corresponding to the first symbol sequence A[n] in a segmented phase modulator. In FIG. 2E, the first electro-optical conversion unit is an EO MOD unit corresponding to the first symbol sequence A[n] in an optical frequency comb-based combination signal transmitter.

In some embodiments, when the first electro-optical conversion unit is a laser or a partial modulation unit of the laser, the to-be-measured signal correspondingly is an output signal of a transmitter or a sub-signal of the transmitter.

In some embodiments, in operation 102, the second signal is a symbol sequence of the second electro-optical conversion unit, which is referred to as a second symbol sequence B[n] in the present disclosure. The second electro-optical conversion unit modulates to-be-modulated light input thereto according to the second symbol sequence B[n], to obtain a correlation signal, the correlation signal is also a high-speed signal and an optical signal. The to-be-modulated light of the second electro-optical conversion unit may be the same as or different from the to-be-modulated light corresponding to the first electro-optical conversion unit.

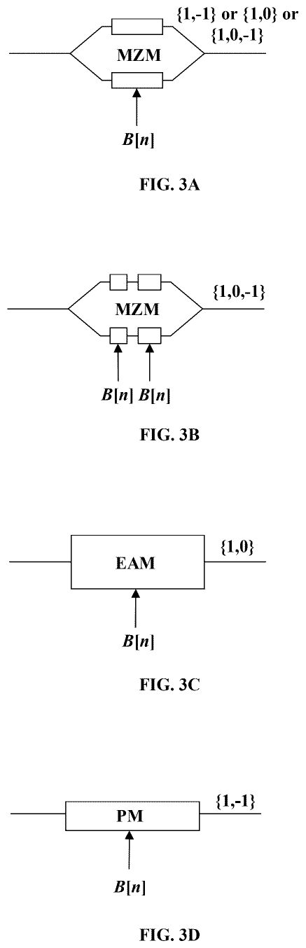

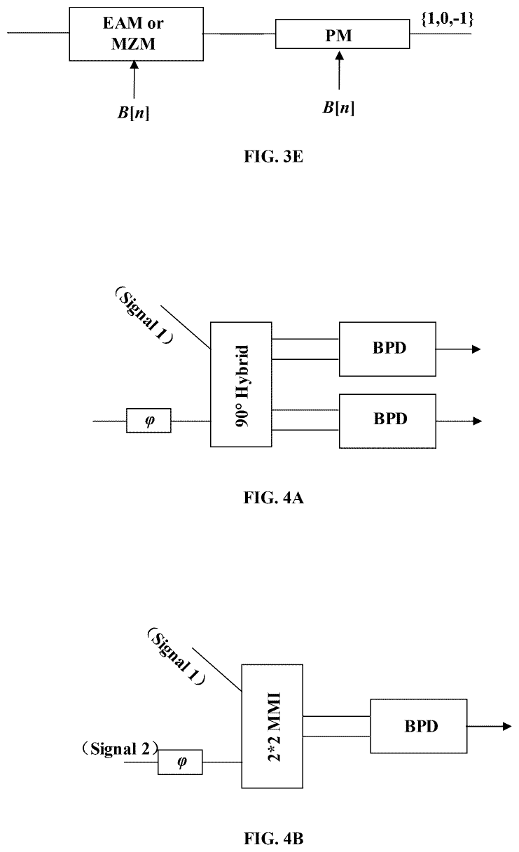

In some embodiments, the second electro-optical conversion unit is a unit with a modulation function and being capable of generating a high-speed signal. In the present disclosure, the second electro-optical conversion unit may be an existing electro-optical conversion unit. FIGS. 3A, 3B, 3C, 3D to FIG. 3E are schematic diagrams of a second electro-optical conversion unit in the embodiments of the present disclosure. In FIG. 3A, the second electro-optical conversion unit is an MZ-type modulator (MZM) with one modulation unit. In FIG. 3B, the second electro-optical conversion unit is an MZ-type modulator (MZM) with two modulation units having an equal length. In FIG. 3C, the second electro-optical conversion unit is an electro absorption modulator (EAM). In FIG. 3D, the second electro-optical conversion unit is a phase modulator (PM). In FIG. 3E, the second electro-optical conversion unit is a structure in which an amplitude modulator (such as an MZ-type modulator (MZM) or an electro absorption modulator (EAM)) and a phase modulator (PM) are connected in series.

In some embodiments, the second electro-optical conversion unit outputs a finite number of states. In this case, the second electro-optical conversion unit outputs a symbol sequence with finite values, for example, a value set of the symbol sequence output by the second electro-optical conversion unit may be {1, −1}, {1, 0} or {1, 0, −1}. For example, for the second electro-optical conversion unit shown in FIG. 3A, a value of a second symbol sequence B[n] input thereto is +1, and a value of a symbol sequence output therefrom may be {1, −1}, {1, 0} or {1, 0, −1}. For the second electro-optical conversion unit shown in FIG. 3B, a value of a second symbol sequence B[n] input thereto is +1, and a value of a symbol sequence output therefrom may be {1, 0, −1}. For the second electro-optical conversion unit shown in FIG. 3C, a value of a second symbol sequence B[n] input thereto is 1 and 0, and a value of a symbol sequence output therefrom may be {1, 0}. For the second electro-optical conversion unit shown in FIG. 3D, a value of a second symbol sequence B[n] input thereto is +1, and a value of a symbol sequence output therefrom may be {1, −1}. For the second electro-optical conversion unit shown in FIG. 3E, when it is a structure in which an MZ-type modulator (MZM) and a phase modulator (PM) are connected in series, a value of a second symbol sequence B[n] input by the MZM is +1, a value of a second symbol sequence B[n] input by the PM is ±1, and a value of a symbol sequence output by the second electro-optical conversion unit may be {1, 0, −1}; and when it is a structure in which an electro absorption modulator (EAM) and a phase modulator (PM) are connected in series, a value of a second symbol sequence B[n] input by the EAM is 1 and 0, a value of a second symbol sequence B[n] input by the PM is ±1, and a value of a symbol sequence output by the second electro-optical conversion unit may be {1, 0, −1}.

When the second electro-optical conversion unit only outputs a finite number of states, only logical operation is performed in the second electro-optical conversion unit, hence the complexity and power consumption of a system are greatly reduced; and also, a nonlinear effect requirement of the system on the second electro-optical conversion unit is also greatly reduced.

In some embodiments, in the operation 103, a first product signal of the to-be-measured signal and the correlation signal is determined via a photoelectric method.

And that a first product signal of the to-be-measured signal and the correlation signal is determined via a photoelectric method includes:
performing photoelectric conversion and a multiplication operation on the sum of the optical signal of the to-be-measured signal and the optical signal of the correlation signal, to obtain the first product signal.

As described above, the to-be-measured signal output by the first electro-optical conversion unit and the correlation signal output by the second electro-optical conversion unit are both optical signals; when the photoelectric method is adopted, these two optical signals i.e., the to-be-measured signal and the correlation signal are combined into one optical signal, then photoelectric conversion and a multiplication operation are performed on the combined optical signal, to obtain a first product signal of the to-be-measured signal and the correlation signal, and the first product signal is an electrical signal.

In some embodiments, when a first product signal of the to-be-measured signal and the correlation signal is determined via a photoelectric method, the first electro-optical conversion unit and the second electro-optical conversion unit are connected in parallel, and an optical signal of the to-be-measured signal is output by the first electro-optical conversion unit and an optical signal of the correlation signal is output by the second electro-optical conversion unit.

In some embodiments, when a first product signal of the to-be-measured signal and the correlation signal is determined via a photoelectric method, the first electro-optical conversion unit and the second electro-optical conversion unit are modulation units of different modulators. For example, the first electro-optical conversion unit is any one of the first electro-optical conversion units shown in FIGS. 2A, 2B, 2C, 2D to FIG. 2E, and the second electro-optical conversion unit is any one of the second electro-optical conversion units shown in FIGS. 3A, 3B, 3C, 3D to FIG. 3E. For another example, for a coherence transmitter, it includes two sub-modulators on I channel and Q channel, the first electro-optical conversion unit is one modulation unit on the I channel, and the second electro-optical conversion unit correspondingly is one or more modulation units on the Q channel; or, the first electro-optical conversion unit is one modulation unit on the Q channel, and the second electro-optical conversion unit correspondingly is one or more modulation units on the I channel.

In some embodiments, when a first product signal of the to-be-measured signal and the correlation signal is determined via a photoelectric method, the first electro-optical conversion unit and the second electro-optical conversion unit are different modulation units of the same modulator. For example, for a transmitter including a plurality of modulation units, one of modulation units included by the transmitter serves as the first electro-optical conversion unit, and the remaining one or more modulation units serve(s) as the second electro-optical conversion unit. For a coherence transmitter, it includes two sub-modulators on I channel and Q channel, the first electro-optical conversion unit is one modulation unit on the I channel, and the second electro-optical conversion unit correspondingly is the remaining one or more modulation units on the I channel; or, the first electro-optical conversion unit is one modulation unit on the Q channel, and the second electro-optical conversion unit correspondingly is the remaining one or more modulation units on the Q channel.

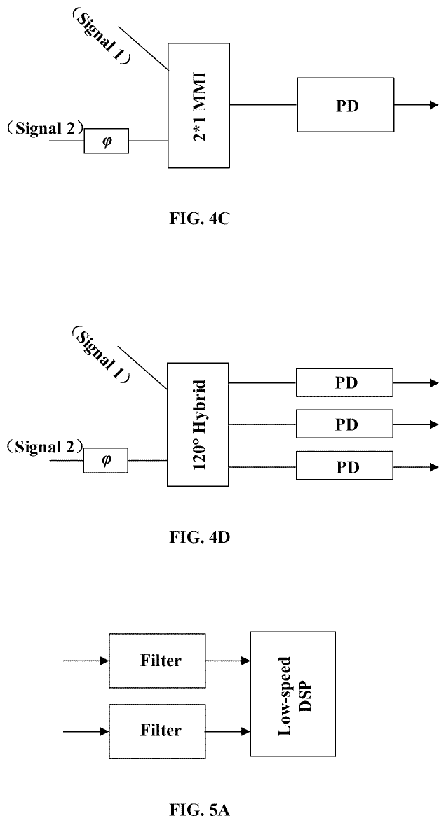

In some embodiments, the photoelectric method is implemented via a photoelectric multiplier, wherein a photoelectric detector, a balanced detector, a coherent detector, etc., may be used for photoelectric conversion. FIGS. 4A, 4B, 4C to FIG. 4D are schematic diagrams of a photoelectric multiplier in the embodiments of the present disclosure. In FIG. 4A, the photoelectric multiplier includes a phase shifter (φ), a 90-degree frequency mixer (90° hybrid) and two balanced detectors (BPD). In FIG. 4B, the photoelectric multiplier includes a phase shifter (φ), a beam combiner and a balanced detector (BPD), wherein the beam combiner e.g., is 2*2 MMI. In FIG. 4C, the photoelectric multiplier includes a phase shifter (?), a beam combiner and a single detector (PD), wherein the beam combiner e.g., is 2*1 MMI or a Y beam combiner, etc. In FIG. 4D, the photoelectric multiplier includes a phase shifter (4), a 120-degree frequency mixer (120° hybrid) and a plurality of single detectors (PDs), for example it includes three PDs.

In FIG. 4A to FIG. 4D, phase shifters are optional, that is, the phase shifters may or may not be included in the photoelectric multiplier in FIG. 4A to FIG. 4D.

In FIG. 4A to FIG. 4D, the photoelectric multiplier has two input signals, i.e., signal 1 and signal 2. In the present disclosure, one of signals 1 and 2 is a to-be-measured signal output by the first electro-optical conversion unit, and the other of signals 1 and 2 is a correlation signal output by the second electro-optical conversion unit. An output signal of the photoelectric multiplier includes the product of the to-be-measured signal and the correlation signal, that is, a first product signal.

In some embodiments, in the operation 103, a first product signal of the to-be-measured signal and the correlation signal is determined via an optical method.

And that a first product signal of the to-be-measured signal and the correlation signal is determined via an optical method includes:
performing photoelectric conversion on the product of the optical signal of the to-be-measured signal and the optical signal of the correlation signal, to obtain the first product signal.

As described above, the to-be-measured signal output by the first electro-optical conversion unit and the correlation signal output by the second electro-optical conversion unit are optical signals, when the optical method is adopted, first, these two optical signals i.e., the to-be-measured signal and the correlation signal are multiplied to obtain an optical signal of the product of the to-be-measured signal and the correlation signal, then photoelectric conversion is performed on the optical signal of the product, to obtain an electrical signal of the product of the to-be-measured signal and the correlation signal, i.e., the first product signal.

In some embodiments, when a first product signal of the to-be-measured signal and the correlation signal is determined via an optical method, the first electro-optical conversion unit and the second electro-optical conversion unit are connected in series, and the product of an optical signal of the to-be-measured signal and an optical signal of the correlation signal is output after the first electro-optical conversion unit and the second electro-optical conversion unit are connected in series.

In some embodiments, when a first product signal of the to-be-measured signal and the correlation signal is determined via an optical method, the first electro-optical conversion unit and the second electro-optical conversion unit are modulation units of different modulators. For example, the first electro-optical conversion unit is any one of the first electro-optical conversion units shown in FIGS. 2A, 2B, 2C, 2D to FIG. 2E, and the second electro-optical conversion unit is any one of the second electro-optical conversion units shown in FIG. 3A to FIG. 3E.

In some embodiments, the optical method is implemented via an optical multiplier. The structure in which the first electro-optical conversion unit and the second electro-optical conversion unit are connected in series corresponds to an optical multiplier, which multiplies a to-be-measured signal and a correlation signal on an optical domain. Thus, a signal output after the first electro-optical conversion unit and the second electro-optical conversion unit are connected in series is an optical signal of the product of the to-be-measured signal and the correlation signal. Then, the first product signal is obtained by converting the optical signal of the product of the to-be-measured signal and the correlation signal into an electrical signal via a photoelectric conversion unit.

The structure of the photoelectric conversion unit for example is similar to that of the photoelectric multiplier shown in FIG. 4A to FIG. 4D. A difference is that when the optical method is used, the photoelectric multiplier in FIG. 4A to FIG. 4D is used as a photoelectric conversion unit. In this case, one of two input signals, i.e., signal 1 and signal 2, is a signal output after the first electro-optical conversion unit and the second electro-optical conversion unit are connected in series, that is, an optical signal of the product of the to-be-measured signal and the correlation signal, and the other is direct current light.

The photoelectric conversion unit is further e.g., a single detector (PD). When the first electro-optical conversion unit and the second electro-optical conversion unit are modulation units of an amplitude modulator, a to-be-measured signal output by the first electro-optical conversion unit and a correlation signal output by the second electro-optical conversion unit are both amplitude modulated signals, and a series structure of the first electro-optical conversion unit and the second electro-optical conversion unit multiplies these two amplitude modulated signals i.e., the to-be-measured signal and the correlation signal, to obtain a product of these two signals on an optical domain, that is, an optical signal of the product of the to-be-measured signal and the correlation signal, which is represented by a change in a signal amplitude. In this case, the optical signal of the product may be detected by a single detector (PD), and an electrical signal of the product is output, that is, a first product signal of the to-be-measured signal and the correlation signal.

In some embodiments, in the operation 104, correlation of the to-be-measured signal and the correlation signal is determined by performing an electrical average operation on the first product signal.

The electrical average operation may be implemented in an analog domain, for example, the electrical average operation on the first product signal may be implemented via an analog circuit. The electrical average operation may further be implemented in a digital domain, for example, after analog-to-digital conversion is performed on the first product signal, the electrical average operation of a digital signal corresponding to the first product signal is implemented via a digital circuit.

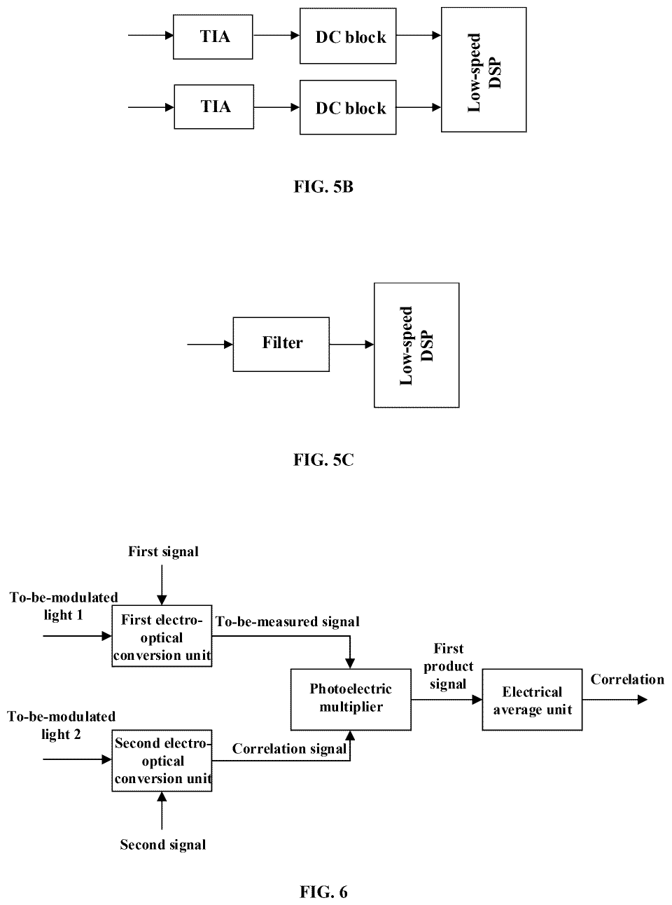

In some embodiments, the electrical average operation is implemented via an electrical average unit. For example, signal averaging is achieved via a low-pass filter or a low-speed DSP. FIGS. 5A, 5B to FIG. 5C are schematic diagrams of an electrical average unit in the embodiments of the present disclosure. In FIG. 5A, the electrical average unit includes two low-pass filters and one low-speed digital signal processor (low-speed DSP). In FIG. 5B, the electrical average unit includes two electrical devices TIA/DC block filters and one low-speed digital signal processor (Low-speed DSP). In FIG. 5C, the electrical average unit includes one low-pass filter and one low-speed digital signal processor (low-speed DSP).

A method for determining signal correlation by using a photoelectric method will be specifically described below respectively via the embodiments of the present disclosure.

FIG. 6 is a schematic diagram of a method for determining signal correlation by using a photoelectric method in the embodiments of the present disclosure. With reference to FIG. 1, when using the photoelectric method, the first electro-optical conversion unit and the second electro-optical conversion unit are connected in parallel. In this case, a first signal, that is, a first symbol sequence A[n], is input to the first electro-optical conversion unit, so that the first electro-optical conversion unit modulates to-be-modulated light 1 and outputs a to-be-measured signal; a second signal, that is, a second symbol sequence B[n], is input to the second electro-optical conversion unit, so that the second electro-optical conversion unit modulates to-be-modulated light 2 and outputs a correlation signal; then the independent to-be-measured signal and the correlation signal are input to a photoelectric multiplier respectively, and photoelectric conversion is performed by using the photoelectric multiplier to obtain a first product signal of the to-be-measured signal and the correlation signal; then the first product signal is input to an electrical average unit, an electrical average operation is performed by using the electrical average unit, and correlation of the to-be-measured signal and the correlation signal is output.

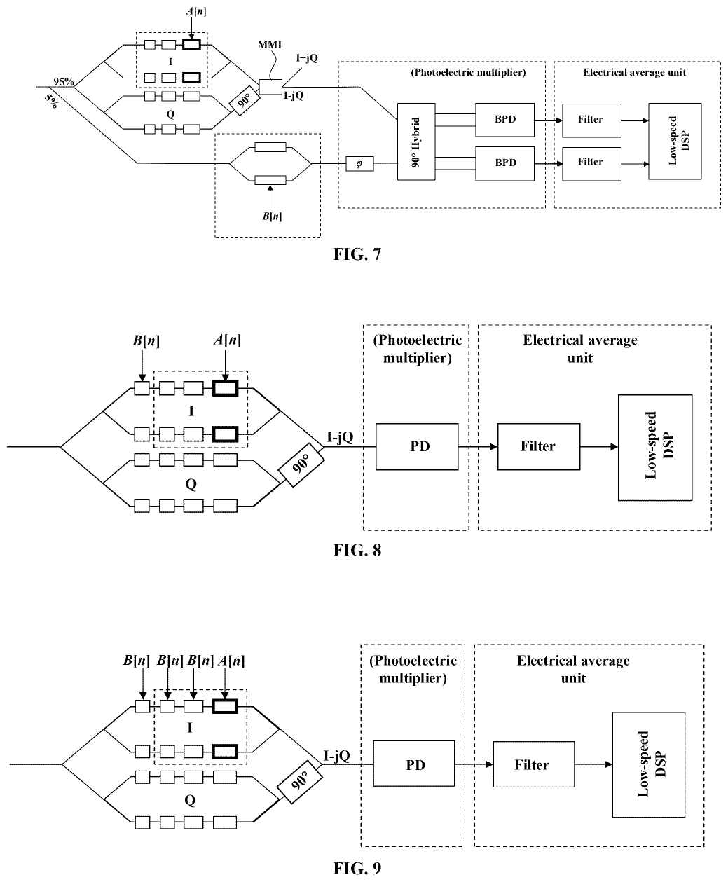

FIGS. 7, 8, 9 to FIG. 10 are schematic diagrams of a hardware structure for implementation of the method shown in FIG. 6, as provided by the embodiments of the present disclosure. The structure includes a first electro-optical conversion unit, a second electro-optical conversion unit, a photoelectric multiplier and an electrical average unit. The first electro-optical conversion unit may be any one of the first electro-optical conversion units shown in FIGS. 2A, 2B, 2C, 2D to FIG. 2E, or other structures. The second electro-optical conversion unit may be any one of the second electro-optical conversion units shown in FIGS. 3A, 3B, 3C, 3D to FIG. 3E, or other structures. The photoelectric multiplier may be any one of the photoelectric multipliers shown in FIGS. 4A, 4B, 4C to FIG. 4D, or other structures. The electrical average unit may be any one of the electrical average units shown in FIGS. 5A, 5B to FIG. 5C, or other structures.

For example, in the structure shown in FIG. 7, the first electro-optical conversion unit adopts the structure shown in FIG. 2A, the second electro-optical conversion unit adopts the structure shown in FIG. 3A, the photoelectric multiplier adopts the structure shown in FIG. 4A, and the electrical average unit adopts the structure shown in FIG. 5A. In FIG. 7, the first electro-optical conversion unit is a part of a transmitter, the first electro-optical conversion unit and the second electro-optical conversion unit are connected in parallel, and multiplication of a to-be-measured signal output by the first electro-optical conversion unit and a correlation signal output by the second electro-optical conversion unit is achieved by coherent reception. Therefore, the implementation scheme shown in FIG. 7 is also called a “parallel modulation+coherent detection” scheme.

In FIG. 7, to-be-modulated light of the first electro-optical conversion unit and of the second electro-optical conversion unit are both direct current light, and before a modulator, a part of the direct current light (e.g. 95%) is transmitted to the first electro-optical conversion unit, and the other part (e.g. 5%) is transmitted to the second electro-optical conversion unit. A coherence transmitter has a plurality of output ports, so a to-be-measured signal output therefrom may be included in an output signal I+jQ at an I+jQ detection end, or in an output signal I−jQ at an I−jQ detection end, or in an output signal of other detection branches. Acquisition of an output signal may be achieved by a beam splitter, through which a part of the output signal (e.g. 5%) is split and is applied in the present disclosure, and for details, related arts may be referred to. FIG. 7 takes that a to-be-measured signal is included in an output signal I−jQ at an I−jQ detection end as an example, however the present disclosure is not limited to this.

Inputs of the photoelectric multiplier are a to-be-measured signal output by the first electro-optical conversion unit and a correlation signal output by the second electro-optical conversion unit, and outputs of the photoelectric multiplier is two electrical signals in an in-phase channel and a quadrature channel. Low-pass filtering of an electrical signal and low-speed DSP are included in an electrical average unit, and an electrical average operation may be realized in an analog domain or a digital domain.

Example of the structure shown in FIG. 7 to determine correlation is provided as follows:

An output signal of the coherence transmitter containing the first electro-optical conversion unit is denoted as E_{sig}(t), the output signal containing a to-be-measured signal E₁(t) output by the first electro-optical conversion unit, and a correlation signal output by the second electro-optical conversion unit is E₂(t), and an optical phase bias between E_{sig} (t) and E₂(t) is φ. After an ideal 90-degree frequency mixer (90° hybrid), an output optical signal may be denoted as:

$$\frac{1}{2} [ \begin{matrix}{E}_{Sig} ( t ) - {E}_{2} ( t ) {e}^{j φ} \\ j ( {E}_{Sig} ( t ) + {E}_{2} ( t ) {e}^{j φ} ) \\ j ( {E}_{Sig} ( t ) - {jE}_{2} ( t ) {e}^{j φ} ) \\ - ( {E}_{Sig} ( t ) - {jE}_{2} ( t ) {e}^{j φ} )\end{matrix} ] \qquad Equation ( 7 - 1 )$$

Subsequently, output currents of two balanced detectors (BPDs) may be written respectively:

$$\begin{matrix}{I}_{BPD 1} ( t ) = \frac{{R}_{BPD}}{4} ( {\vert {E}_{Sig} ( t ) + {E}_{2} ( t ) {e}^{j φ} \vert}^{2} - {\vert {E}_{Sig} ( t ) - {E}_{2} ( t ) {e}^{j φ} \vert}^{2} ) \\ = {R}_{BPD} [ {E}_{sig} ( t ) {E}_{2}^{*} ( t ) {e}^{- j φ} + {E}_{sig}^{*} ( t ) {E}_{2} ( t ) {e}^{j φ} ] / 2\end{matrix} \qquad Equation ( 7 - 2 )$$

$$\begin{matrix}{I}_{BPD 2} ( t ) = \frac{{R}_{BPD}}{4} ( {\vert {E}_{Sig} ( t ) + {jE}_{2} ( t ) {e}^{j φ} \vert}^{2} - {\vert {E}_{Sig} ( t ) - {jE}_{2} ( t ) {e}^{j φ} \vert}^{2} ) \\ = {R}_{BPD} [ - {jE}_{sig} ( t ) {E}_{2}^{*} ( t ) {e}^{- j φ} + {jE}_{sig}^{*} ( t ) {E}_{2} ( t ) {e}^{j φ} ] / 2 \\ = {R}_{BPD} [ {E}_{sig} ( t ) {E}_{2}^{*} ( t ) {e}^{- j ( φ + π / 2 )} + {E}_{sig}^{*} ( t ) {E}_{2} ( t ) {e}^{j ( φ + π / 2 )} ] / 2\end{matrix} \qquad Equation ( 7 - 3 )$$

In the above Equations, R_{BPD} is a response of a balanced detector, and φ is a constant phase. Since E_{sig}(t) contains E₁(t), I_{BPD1}(t) and I_{BPD2}(t)) output by the photoelectric multiplier contain information on E₁(t)E₂(t). Via the electrical average unit, correlation of two high-speed signals may be obtained.

In some embodiments, the second electro-optical conversion unit and the first electro-optical conversion unit are on the same modulator. As shown in FIG. 8, the first electro-optical conversion unit adopts the structure shown in FIG. 2A, an additional modulation segment may be added on a modulator where the first electro-optical conversion unit is located as a second electro-optical conversion unit, that is, the modulation unit into which the second symbol sequence B[n] is input in FIG. 8. By taking the structure shown in FIG. 8 as an example, the first electro-optical conversion unit and the second electro-optical conversion unit convert a high-speed electrical signal into optical phase information, that is, a to-be-measured signal and a correlation signal, and phases of the two signals are superimposed and then are output via an MZ modulator. The photoelectric multiplier is implemented by a single detector (PD), and a square operation of the PD multiplies the two signals. The electrical average operation is implemented by the electrical average unit shown in FIG. 5C.

In the scheme shown in FIG. 8, one modulation segment is used as a second electro-optical conversion unit. In some other implementations, other available modulation segments on a modulator where the first electro-optical conversion unit is located may be all used as second electro-optical conversion units if an impact of the correlation signal on a main signal is not taken into account, as shown in FIG. 9.

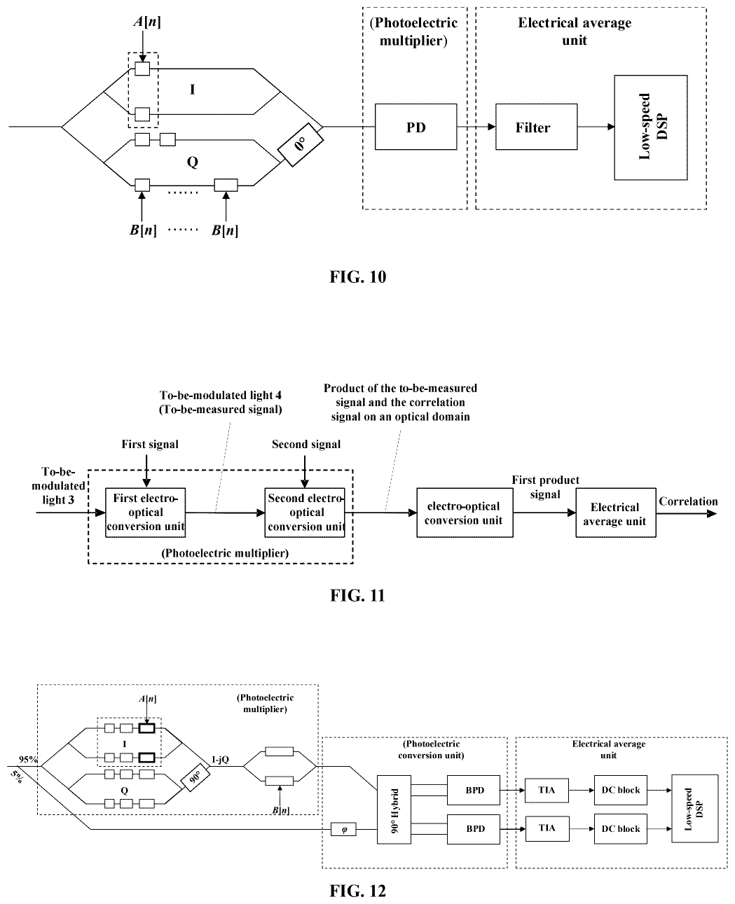

In some embodiments, the second electro-optical conversion unit and the first electro-optical conversion unit are on different modulators. As shown in FIG. 10, the first electro-optical conversion unit adopts the structure shown in FIG. 2A, that is, the first electro-optical conversion unit is a modulation unit on a sub-modulator of a branch of a coherence transmitter. The second electro-optical conversion unit adopts one or more modulation units on a sub-modulator of another branch of the coherence transmitter. When the first electro-optical conversion unit is a modulation segment on I channel of the coherence transmitter, the second electro-optical conversion unit is one or more modulation segments on Q channel of the coherence transmitter, vice versa. In FIG. 10, it is required that the I channel and Q channel of the coherence transmitter is not quadrature, that is, a phase bias between the I channel and Q channel is not equal to 90° or −90°, for example may be 0°.

A method for determining signal correlation by using an optical method will be specifically described below respectively via the embodiments of the present disclosure.

FIG. 11 is a schematic diagram of a method for determining signal correlation by using an optical method in the embodiments of the present disclosure. With reference to FIG. 11, when the optical method is adopted, the first electro-optical conversion unit and the second electro-optical conversion unit are connected in series to form an optical multiplier. In this case, a first signal, that is, a first symbol sequence A[n], is input to the first electro-optical conversion unit, so that the first electro-optical conversion unit modulates to-be-modulated light 3 to form a to-be-measured signal. A second signal, that is, a second symbol sequence B[n], is input to the second electro-optical conversion unit, so that the second electro-optical conversion unit modulates to-be-modulated light 4 to form a correlation signal. As shown in FIG. 11, when an output end of the first electro-optical conversion unit is connected in series to an input end of the second electro-optical conversion unit, the to-be-modulated light 3 may be direct current light, and the to-be-modulated light 4 includes a to-be-measured signal output by the first electro-optical conversion unit. Otherwise, when an output end of the second electro-optical conversion unit is connected in series to an input end of the first electro-optical conversion unit (not shown), the to-be-modulated light 4 may be direct current light, and the to-be-modulated light 3 includes a correlation signal output by the second electro-optical conversion unit. Since the first electro-optical conversion unit and the second electro-optical conversion unit are connected in series to form an optical multiplier, this series structure outputs a product of a to-be-measured signal and a correlation signal in an optical domain, that is, an optical signal of the product of the to-be-measured signal and the correlation signal; then the optical signal of the product of the to-be-measured signal and the correlation signal is input to a photoelectric conversion unit, and the photoelectric conversion unit is used to carry out photoelectric conversion, to obtain an electrical signal of the product of the to-be-measured signal and the correlation signal, that is, a first product signal of the to-be-measured signal and the correlation signal; subsequently, the first product signal is input to an electrical average unit, the electrical average unit is used to perform an electrical average operation, and correlation of the to-be-measured signal and the correlation signal is output.

FIGS. 12, 13 to FIG. 14 are schematic diagrams of a hardware structure for implementation of the method shown in FIG. 11, as provided by the embodiments of the present disclosure. The structure includes a first electro-optical conversion unit, a second electro-optical conversion unit, a photoelectric conversion unit and an electrical average unit. The first electro-optical conversion unit may be any one of the first electro-optical conversion units shown in FIGS. 2A, 2B, 2C, 2D to FIG. 2E, or other structures. The second electro-optical conversion unit may be any one of the second electro-optical conversion units shown in FIGS. 3A, 3B, 3C, 3D to FIG. 3E, or other structures. The photoelectric conversion unit may be a structure of any one of the photoelectric multipliers shown in FIGS. 4A, 4B, 4C to FIG. 4D, or other structures. The electrical average unit may be any one of the electrical average units shown in FIG. 5A to FIG. 5C, or other structures.

For example, in the structure shown in FIG. 12, the first electro-optical conversion unit adopts the structure shown in FIG. 2A, the second electro-optical conversion unit adopts the structure shown in FIG. 3A, the photoelectric conversion unit adopts the structure shown in FIG. 4A, and the electrical average unit adopts the structure shown in FIG. 5B. In FIG. 12, the first electro-optical conversion unit is part of a coherence transmitter, the first electro-optical conversion unit and the second electro-optical conversion unit are connected in series to form an optical multiplier, so that a to-be-measured signal multiplies with a correlation signal on an optical domain. Before a modulator, a part (e.g. 95%) of direct current light is transmitted to the first electro-optical conversion unit in which the part of direct current light forms a to-be-measured signal. The to-be-measured signal is included in an output signal of an output port (such as an I+jQ detection end or an I−jQ detection end or other detection end) of the coherence transmitter. An input end of the second electro-optical conversion unit is connected to a corresponding output port of the coherence transmitter, and an input signal containing the to-be-measured signal is modulated, thereby outputting a product of the to-be-measured signal and the correlation signal in the optical domain.

Two inputs of the photoelectric conversion unit are respectively a product of the to-be-measured signal and the correlation signal in the optical domain, and a part (such as 5%) of the direct current light that is split.

The implementation scheme shown in FIG. 12 is also called a “series modulation+coherent detection” scheme.

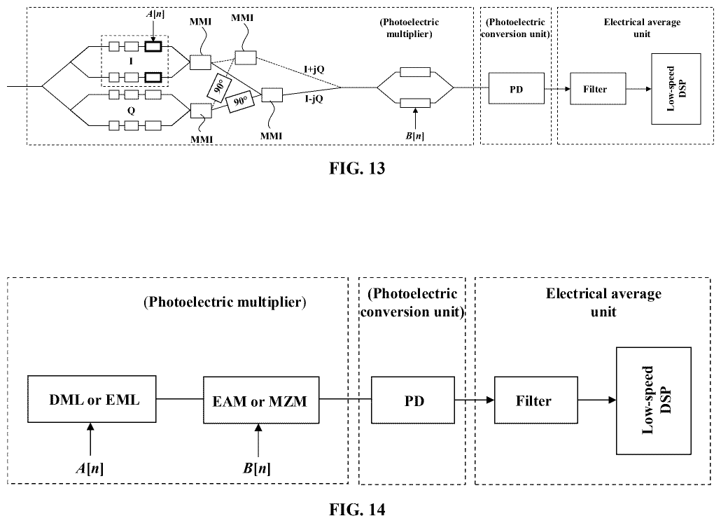

For another example, in the structure shown in FIG. 13, the first electro-optical conversion unit adopts the structure shown in FIG. 2A, the second electro-optical conversion unit adopts the structure shown in FIG. 3A, the photoelectric conversion unit adopts a single detector (PD), and the electrical average unit adopts the structure shown in FIG. 5C. In FIG. 13, the first electro-optical conversion unit and the second electro-optical conversion unit are connected in series, and form an optical multiplier via a waveguide structure, so that the to-be-measured signal multiplies with the correlation signal on the optical domain. The single detector (PD) implements a photoelectric conversion function, and obtains an electrical signal of a product of the to-be-measured signal and the correlation signal, that is, a first product signal. The electrical average unit performs an electrical average operation on the first product signal to output correlation of the to-be-measured signal and the correlation signal.

The implementation scheme shown in FIG. 13 is also called a “series modulation+direct detection” scheme.

The optical multiplier in FIG. 12 and FIG. 13 is implemented as follows:

By taking FIG. 13 as an example, assuming that all the beam combiners MMI in the coherence transmitter adopt 2*2 MMI, signals at two output ports of the I-channel modulator may be written as sin(φ_{I}(t)) and cos(φ_{I}(t)) respectively, and φ_{I}(t) is an optical phase modulated by an I-channel electrical signal.

Main output signal of the IQ modulator is a signal after 2*2 MMI of the mother MZ, and may be simplified as sin (φ_{I}(t))+jsin (φ_{Q}(t)); the other output is sin (φ_{I} (t))−jsin (φ_{Q}(t)). Signal output from the other port of the I modulator and the Q modulator may further be combined with the 2*2 MMI using a phase shifter to obtain a signal cos (φ_{I}(t))−jcos(φ_{Q}(t)). By combining these two signals using a beam combiner, the following signal may be obtained:

$$cos ( {φ}_{I} ( t ) ) - j cos ( {φ}_{Q} ( t ) ) + sin ( {φ}_{I} ( t ) ) - j sin ( {φ}_{Q} ( t ) ) = \sqrt{2} [ sin ( {φ}_{I} ( t ) + \frac{π}{4} ) - j sin ( {φ}_{Q} ( t ) + \frac{π}{4} ) ] \qquad Equation ( 13 - 1 )$$

The Equation (13-1) shows that two amplitude-modulated signals (equivalent to signals output by a modulator biased at a quadrature point) which act as real and imaginary parts of a total output signal may be constructed by using an optical method.

The second electro-optical conversion unit may also output an amplitude-modulated signal (such as an MZ modulator biased at a quadrature point).

For another example, in the structure shown in FIG. 14, the first electro-optical conversion unit adopts the structure shown in FIG. 2C, the second electro-optical conversion unit adopts the structure shown in FIG. 3A, 3B or 3C, the photoelectric conversion unit adopts a single detector (PD), and the electrical average unit adopts the structure shown in FIG. 5C. In FIG. 14, the first electro-optical conversion unit and the second electro-optical conversion unit are connected in series, and form an optical multiplier, so that the to-be-measured signal multiplies with the correlation signal on the optical domain. The single detector (PD) implements a photoelectric conversion function, and obtains an electrical signal of a product of the to-be-measured signal and the correlation signal, that is, a first product signal. The electrical average unit performs an electrical average operation on the first product signal to output correlation of the to-be-measured signal and the correlation signal.

Before a modulator, a part (e.g. 95%) of direct current light is transmitted to the first electro-optical conversion unit in which the part of direct current light forms a to-be-measured signal. The to-be-measured signal is included in an output signal of an output port (such as an I+jQ detection end or an I−jQ detection end or other detection end) of the coherence transmitter. An input end of the second electro-optical conversion unit is connected with a corresponding output port of the coherence transmitter, and an input signal containing the to-be-measured signal is modulated, thereby outputting a product of the to-be-measured signal and the correlation signal in the optical domain.

Through the above embodiments, the present disclosure determines a product of high-speed signals output by two electro-optical conversion units by using an optical method or photoelectric method, and further obtains correlation of these two high-speed signals via an electrical average operation. Through the present disclosure, using a large-bandwidth multiplier is avoided, only a low-bandwidth electrical device is used to obtain correlation of two high-speed signals; an implementation mode is flexible, it may be implemented in an integrated or non-integrated manner; application scenarios are rich, suitable for characteristic monitoring of high-speed signals/sub-signals in a variety of transmitters.

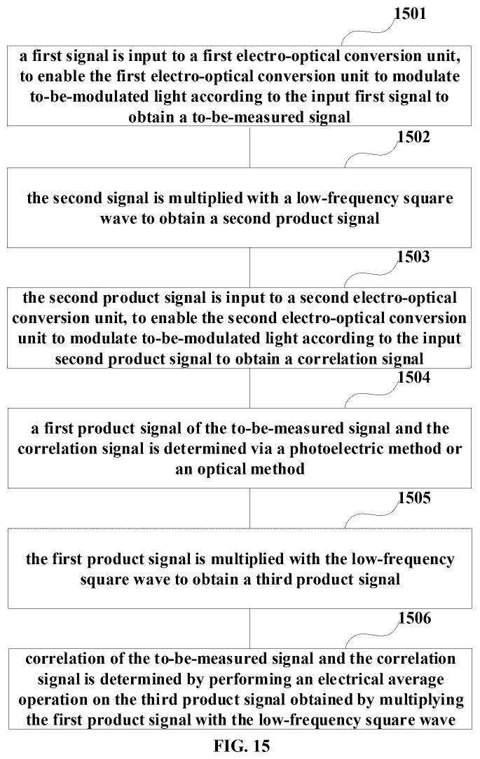

FIG. 15 is a schematic diagram of a method for determining signal correlation in the embodiments of the present disclosure. As shown in FIG. 15, the method includes:
1501, a first signal is input to a first electro-optical conversion unit, to enable the first electro-optical conversion unit to modulate to-be-modulated light according to the input first signal and to obtain a to-be-measured signal;
1502, the second signal is multiplied with a low-frequency square wave to obtain a second product signal;
1503, the second product signal is input to a second electro-optical conversion unit, to enable the second electro-optical conversion unit to modulate to-be-modulated light according to the input second product signal and to obtain a correlation signal;
1504, a first product signal of the to-be-measured signal and the correlation signal is determined via a photoelectric method or an optical method;
1505, the first product signal is multiplied with the low-frequency square wave to obtain a third product signal; and
1506, correlation of the to-be-measured signal and the correlation signal is determined by performing an electrical average operation on the third product signal obtained by multiplying the first product signal with the low-frequency square wave.

It should be noted that the above FIG. 15 only schematically describes the embodiments of the present disclosure, but the present disclosure is not limited to this. For example, some of the above steps may be performed simultaneously or in a sequential order, an execution step of each operation may be adjusted appropriately, moreover other some operations may be increased or reduced. Persons skilled in the art may make appropriate modifications according to the above contents, not limited to the records in the above FIG. 15.

In some embodiments, in operation 1501, the first signal is an input symbol sequence of the first electro-optical conversion unit, i.e., a first input symbol sequence A[n]. The first electro-optical conversion unit is a transmitter per se, or a partial modulation unit of the transmitter, the first electro-optical conversion unit is, for example, the structure shown in FIGS. 2A, 2B, 2C, 2D to FIG. 2E or other structure. The to-be-measured signal is a high-speed signal and is an optical signal. For contents related to the first signal, the first electro-optical conversion unit and the to-be-measured signal, see implementation of operation 101.

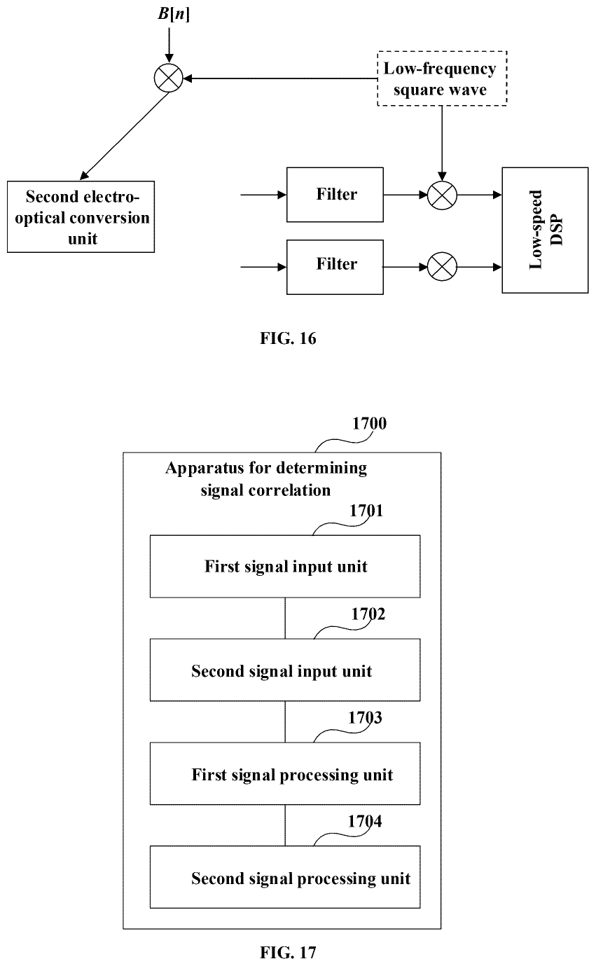

In some embodiments, in operation 1502, multiplication of the second signal with a low-frequency square wave may be implemented by e.g. a multiplier. FIG. 16 is a partial schematic diagram of a hardware structure for implementation of the method shown in FIG. 15, in the embodiments of the present disclosure. As shown in FIG. 16, the second signal B[n] is multiplied with the low-frequency square wave, then a product of B[n] and the low-frequency square wave as a symbol sequence of the second electro-optical conversion unit is input into the second electro-optical conversion unit. Although hardware structures such as the first electro-optical conversion unit, the second electro-optical conversion unit, the photoelectric multiplier/photoelectric conversion unit, etc. are not shown in FIG. 16, persons skilled in the art should understand that FIG. 16 may be combined with any one of the hardware structures shown in FIGS. 7, 8, 9 to FIG. 10 and FIGS. 12, 13 to FIG. 14.

In some embodiments, in operation 1503, the second electro-optical conversion unit is, for example, the structure shown in FIGS. 3A, 3B, 3C, 3D to FIG. 3E or other structure. The correlation signal is also a high-speed signal and an optical signal. For contents related to the second signal, the second electro-optical conversion unit and the correlation signal, see implementation of operation 102.

In some embodiments, in the operation 1504, a first product signal of the to-be-measured signal and the correlation signal is determined via a photoelectric method. Performing photoelectric conversion and a multiplication operation on the sum of the optical signal of the to-be-measured signal and the optical signal of the correlation signal, to obtain the first product signal. When the photoelectric method is adopted, the first electro-optical conversion unit and the second electro-optical conversion unit are connected in parallel, and photoelectric conversion and a multiplication operation of the to-be-measured signal and the correlation signal may be realized via the photoelectric multiplier. For contents related to realization of the photoelectric method and the photoelectric multiplier, see implementation of operation 103.

In some embodiments, in the operation 1504, a first product signal of the to-be-measured signal and the correlation signal is determined via an optical method. performing photoelectric conversion on the product of the optical signal of the to-be-measured signal and the optical signal of the correlation signal, to obtain the first product signal. When the optical method is adopted, the first electro-optical conversion unit and the second electro-optical conversion unit are connected in series, and form an optical multiplier, so as to implement multiplication of the to-be-measured signal and the optical signal of the correlation signal in an optical domain. In addition, photoelectric conversion of the product of the to-be-measured signal and the correlation signal may be realized via a photoelectric conversion unit. For contents related to realization of the optical method and the photoelectric conversion unit, see implementation of operation 103.

In some embodiments, in operation 1505, the first product signal is multiplied with the low-frequency square wave to obtain a third product signal, which may be implemented by e.g. a multiplier. The low-frequency square wave in this operation and the low-frequency square wave in operation 1052 are the same low-frequency square wave.

In some embodiments, in operation 1506, correlation of the to-be-measured signal and the correlation signal is determined by performing an electrical average operation on the third product signal obtained by multiplying the first product signal with the low-frequency square wave. The electrical average operation may be achieved via the electrical average unit, and the multiplier in operation 1505 may be configured in the electrical average unit. For example, referring to FIG. 16, by taking the electrical average unit shown in FIG. 5A as an example, between a low-pass filter of the electrical average unit and a low-speed digital signal processor (low-speed DSP), a multiplier is configured, two inputs of the multiplier are a low-frequency square wave and a first product signal of the to-be-measured signal and the correlation signal, respectively, the output is the third product signal. Correlation of the to-be-measured signal and the correlation signal is obtained after the low-speed digital signal processor (low-speed DSP) performs electrical average operation on the third product signal. For contents related to the electrical average unit and determination of correlation of the to-be-measured signal and the correlation signal, please see implementation of operation 104.

Through the above embodiments, multiplying a square wave with a frequency shift is added to the method for determining signal correlation in the present disclosure, that is, a second product signal obtained by multiplying a low-frequency square wave with a symbol sequence is taken as a symbol sequence of the second electro-optical conversion unit, and in the electrical average operation, the electrical average operation is performed on a third product signal obtained by multiplying a first product signal of the to-be-measured signal and the correlation signal with the low-frequency square wave, and correlation of the to-be-measured signal and the correlation signal is obtained. After the multiplying of a square wave with a frequency shift is added, a calculated correlation may be transferred from DC to a frequency of a low-frequency square wave, thereby avoiding 1/f noise near DC.

The above text schematically describes a method for determining signal correlation and hardware structures for implementing the method, however the present disclosure is not limited to this. The method for determining signal correlation may further include other steps or processes. For specific contents of these steps or processes, please refer to prior arts. In addition, the above text exemplarily describes hardware structures for implementing the method for determining signal correlation, however the present disclosure is not limited to these hardware structures, these structures may further be modified appropriately, implementations of such modifications should be included within the scope of the embodiments of the present disclosure.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

As may be known from the above embodiments, the present disclosure determines a product of high-speed signals output by two electro-optical conversion units by using an optical method or photoelectric method, and further obtains correlation of these two high-speed signals via an electrical average operation. Through the present disclosure, using a large-bandwidth multiplier is avoided, only a low-bandwidth electrical device is used to obtain correlation of two high-speed signals; an implementation mode is flexible, it may be implemented in an integrated or non-integrated manner; application scenarios are rich, suitable for characteristic monitoring of high-speed signals/sub-signals in a variety of transmitters. In addition, a function of multiplying a square wave with a frequency shift may further be added, correlation is transferred from DC to a frequency of a low-frequency square wave, thereby avoiding 1/f noise near DC.

### Embodiments of a Second Aspect

The embodiments of the present disclosure provide an apparatus for determining signal correlation, the contents same as the embodiments of the first aspect are not repeated.

FIG. 17 is a schematic diagram of an apparatus for determining signal correlation in the embodiments of the present disclosure. As shown in FIG. 17, an apparatus 1700 for determining signal correlation includes:
a first signal input unit 1701, configured to input a first signal to a first electro-optical conversion unit, to enable the first electro-optical conversion unit to modulate to-be-modulated light according to the input first signal and to obtain a to-be-measured signal;
a second signal input unit 1702, configured to input a second signal to a second electro-optical conversion unit, to enable the second electro-optical conversion unit to modulate to-be-modulated light according to the input second signal and to obtain a correlation signal;
a first signal processing unit 1703, configured to determine a first product signal of the to-be-measured signal and the correlation signal via a photoelectric method or an optical method; and
a second signal processing unit 1704, configured to determine correlation of the to-be-measured signal and the correlation signal by performing an electrical average operation on the first product signal.

In some embodiments, the first electro-optical conversion unit is a transmitter, or a partial modulation unit of the transmitter.

In some embodiments, the second electro-optical conversion unit outputs a finite number of states.

In some embodiments, the first electro-optical conversion unit and the second electro-optical conversion unit are connected in parallel;
and the first electro-optical conversion unit outputs an optical signal of the to-be-measured signal and the second electro-optical conversion unit outputs an optical signal of the correlation signal.

In some embodiments, the first signal processing unit 1703 includes an optical multiplier, the optical multiplier being used to:
perform photoelectric conversion and a multiplication operation on the sum of the optical signal of the to-be-measured signal and the optical signal of the correlation signal, to obtain the first product signal.

In some embodiments, the first electro-optical conversion unit and the second electro-optical conversion unit are modulation units of different modulators; or
the first electro-optical conversion unit and the second electro-optical conversion unit are different modulation units of the same modulator.

In some embodiments, the first electro-optical conversion unit and the second electro-optical conversion unit are connected in series;
and a product of the optical signal of the to-be-measured signal and the optical signal of the correlation signal is output after the first electro-optical conversion unit and the second electro-optical conversion unit are connected in series.

In some embodiments, the first signal processing unit 1703 includes a photoelectric conversion unit, the photoelectric conversion unit being used to:
perform photoelectric conversion on the product of the optical signal of the to-be-measured signal and the optical signal of the correlation signal, to obtain the first product signal.

In some embodiments, the first electro-optical conversion unit and the second electro-optical conversion unit are modulation units of different modulators.

In some embodiments, the apparatus further includes (not shown):
a first multiplication unit, configured to multiply the second signal with a low-frequency square wave before the second signal is input to the second electro-optical conversion unit, to obtain a second product signal;
and the second signal input unit 1702 is specifically used to:
input the second product signal to the second electro-optical conversion unit, to enable the second electro-optical conversion unit to modulate to-be-modulated light according to the second product signal and to obtain the correlation signal.

In some embodiments, the apparatus further includes (not shown):
a second multiplication unit, configured to multiply the first product signal with the low-frequency square wave before an electrical average operation is performed on the first product signal, to obtain a third product signal;
and the second signal processing unit 1704 includes an electrical average unit, the electrical average unit being specifically used to:
determine correlation of the to-be-measured signal and the correlation signal by performing the electrical average operation on the third product signal obtained by multiplying the first product signal with the low-frequency square wave.

It's worth noting that the above only describes components or modules related to the present disclosure, but the present disclosure is not limited to this. the apparatus 1700 for determining signal correlation may further include other components or modules. For detailed contents of these components or modules, relevant technologies may be referred to.

For the sake of simplicity, FIG. 17 only exemplarily shows a connection relationship or signal direction between components or modules, however persons skilled in the art should know that various relevant technologies such as bus connection may be used. The above components or modules can be realized by a hardware facility such as a processor, a memory, etc. The embodiments of the present disclosure have no limitation to this.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

As may be known from the above embodiments, the present disclosure determines a product of high-speed signals output by two electro-optical conversion units by using an optical method or photoelectric method, and further obtains correlation of these two high-speed signals via an electrical average operation. Through the present disclosure, using a large-bandwidth multiplier is avoided, only a low-bandwidth electrical device is used to obtain correlation of two high-speed signals; an implementation mode is flexible, it may be implemented in an integrated or non-integrated manner; application scenarios are rich, suitable for characteristic monitoring of high-speed signals/sub-signals in a variety of transmitters. In addition, a function of multiplying a square wave with a frequency shift may further be added, correlation is transferred from DC to a frequency of a low-frequency square wave, thereby avoiding 1/f noise near DC.

### Embodiments of a Third Aspect

The embodiments of the present disclosure provide an electronic device, including the apparatus 1700 for determining signal correlation as described in the embodiments of the second aspect, whose contents are incorporated here. The electronic device may be, for example, a computer, server, a workstation, a laptop computer, a smartphone, etc.; however, the embodiments of the present disclosure are not limited to this.

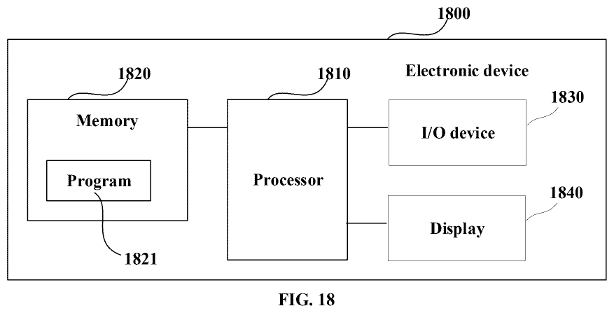

FIG. 18 is a schematic diagram of an electronic device in the embodiments of the present disclosure. As shown in FIG. 18, an electronic device 1800 may include: a processor (such as a central processing unit (CPU)) 1810 and a memory 1820; the memory 1820 is coupled to the central processing unit 1810. The memory 1820 may store various data; moreover, further stores a program 1821 for information processing, and executes the program 1821 under the control of the processor 1810.

In some embodiments, the function of the apparatus 1700 for determining signal correlation is integrated into the processor 1810 for implementation. The processor 1810 is configured to implement a method for determining signal correlation as described in the embodiments of the first aspect.

In some embodiments, the apparatus 1700 for determining signal correlation is configured separately from the processor 1810, for example the apparatus 1700 for determining signal correlation is configured as a chip connected to the processor 1810, a function of the apparatus 1700 for determining signal correlation is realized through the control of the processor 1810.

For example, the processor 1810 is configured to perform the following control:
inputting a first signal to a first electro-optical conversion unit, to enable the first electro-optical conversion unit to modulate to-be-modulated light according to the input first signal and to obtain a to-be-measured signal; inputting a second signal to a second electro-optical conversion unit, to enable the second electro-optical conversion unit to modulate to-be-modulated light according to the input second signal and to obtain a correlation signal; determining a first product signal of the to-be-measured signal and the correlation signal via a photoelectric method or an optical method; and determining correlation of the to-be-measured signal and the correlation signal by performing an electrical average operation on the first product signal.

In addition, as shown in FIG. 18, the electronic device 1800 may further include: an input/output (I/O) device 1830 and a display 1840, etc., wherein the functions of said components are similar to relevant arts, and are not repeated here. It's worth noting that the electronic device 1800 does not have to include all the components shown in FIG. 18. Moreover, the electronic device 1800 may also include components not shown in FIG. 18, relevant technologies may be referred to.

The embodiments of the present disclosure further provide a computer readable program, wherein when an electronic device executes the program, the program enables a computer to execute a method for determining signal correlation as described in the embodiments of the first aspect, in the electronic device.

The embodiments of the present disclosure further provide a storage medium in which a computer readable program is stored, wherein the computer readable program enables a computer to execute a method for determining signal correlation as described in the embodiments of the first aspect, in the electronic device.

The apparatus and method in the present disclosure may be realized by hardware, or may be realized by combining hardware with software. The present disclosure relates to such a computer readable program, when the program is executed by a logic component, the computer readable program enables the logic component to realize the apparatus described in the above text or a constituent component, or enables the logic component to realize various methods or steps described in the above text. The present disclosure further relates to a storage medium storing the program, such as a hard disk, a magnetic disk, an optical disk, a DVD, a flash memory and the like.

By combining with the method/apparatus described in the embodiments of the present disclosure, it may be directly reflected as hardware, a software executed by a processor, or a combination of the two. For example, one or more in the functional block diagram or one or more combinations in the functional block diagram as shown in the drawings may correspond to software modules of a computer program flow, and may also correspond to hardware modules. These software modules may respectively correspond to the steps as shown in the drawings. These hardware modules may be realized by solidifying these software modules e.g. using a field-programmable gate array (FPGA).

A software module may be located in a RAM memory, a flash memory, a ROM memory, an EPROM memory, an EEPROM memory, a register, a hard disk, a mobile magnetic disk, a CD-ROM or a storage medium in any other form as known in this field. A storage medium may be coupled to a processor, thereby enabling the processor to read information from the storage medium, and to write the information into the storage medium; or the storage medium may be a constituent part of the processor. The processor and the storage medium may be located in an ASIC. The software module may be stored in a memory of a mobile terminal, and may also be stored in a memory card of the mobile terminal. For example, if a device (such as the mobile terminal) adopts a MEGA-SIM card with a larger capacity or a flash memory apparatus with a large capacity, the software module may be stored in the MEGA-SIM card or the flash memory apparatus with a large capacity.

One or more in the functional block diagram or one or more combinations in the functional block diagram as described in the drawings may be implemented as a general-purpose processor for performing the functions described in the present disclosure, a digital signal processor (DSP), an application-specific integrated circuit (ASIC), a field-programmable gate array (FPGA) or other programmable logic device, discrete gate or transistor logic device, discrete hardware components or any combination thereof. One or more in the functional block diagram or one or more combinations in the functional block diagram as described in the drawings may further be implemented as a combination of computer equipments, such as a combination of a DSP and a microprocessor, a plurality of microprocessors, one or more microprocessors combined and communicating with the DSP or any other such configuration.

The present disclosure is described by combining with the specific implementations, however persons skilled in the art should clearly know that these descriptions are exemplary and do not limit the protection scope of the present disclosure. Persons skilled in the art can make various variations and modifications to the present disclosure based on the principle of the present disclosure, these variations and modifications are also within the scope of the present disclosure.

As for the implementations including the above embodiments, the following supplements are further disclosed:

Supplement 1. A method for determining signal correlation, the method including:
inputting a first signal to a first electro-optical conversion unit, to enable the first electro-optical conversion unit to modulate to-be-modulated light according to the input first signal and to obtain a to-be-measured signal;
inputting a second signal to a second electro-optical conversion unit, to enable the second electro-optical conversion unit to modulate to-be-modulated light according to the input second signal and to obtain a correlation signal;
determining a first product signal of the to-be-measured signal and the correlation signal via a photoelectric method or an optical method; and
determining correlation of the to-be-measured signal and the correlation signal by performing an electrical average operation on the first product signal.

Supplement 2. The method according to Supplement 1, wherein the first electro-optical conversion unit is a transmitter, or a partial modulation unit of the transmitter.

Supplement 3. The method according to Supplement 1, wherein the second electro-optical conversion unit outputs a finite number of states.

Supplement 4. The method according to Supplement 1, wherein the determining a first product signal of the to-be-measured signal and the correlation signal via a photoelectric method includes:
performing photoelectric conversion and a multiplication operation on the sum of the optical signal of the to-be-measured signal and the optical signal of the correlation signal, to obtain the first product signal,
wherein the first electro-optical conversion unit and the second electro-optical conversion unit are connected in parallel, and an optical signal of the to-be-measured signal is output by the first electro-optical conversion unit and an optical signal of the correlation signal is output by the second electro-optical conversion unit.

Supplement 5. The method according to Supplement 4, wherein the first electro-optical conversion unit and the second electro-optical conversion unit are modulation units of different modulators; or
the first electro-optical conversion unit and the second electro-optical conversion unit are different modulation units of the same modulator.

Supplement 6. The method according to Supplement 1, wherein the determining a first product signal of the to-be-measured signal and the correlation signal via an optical method includes:
performing photoelectric conversion on the product of the optical signal of the to-be-measured signal and the optical signal of the correlation signal, to obtain the first product signal,
wherein the first electro-optical conversion unit and the second electro-optical conversion unit are connected in series, and the product of an optical signal of the to-be-measured signal and an optical signal of the correlation signal is output after the first electro-optical conversion unit and the second electro-optical conversion unit are connected in series.

Supplement 7. The method according to Supplement 6, wherein the first electro-optical conversion unit and the second electro-optical conversion unit are modulation units of different modulators.

Supplement 8. The method according to any one of Supplements 1 to 7, wherein before inputting a second signal to the second electro-optical conversion unit, the method further includes:
multiplying the second signal with a low-frequency square wave to obtain a second product signal;
and inputting the second signal to the second electro-optical conversion unit to modulate to-be-modulated light to obtain a correlation signal includes:
inputting a product of the second product signal and the low-frequency square wave into the second electro-optical conversion unit to modulate direct current light to obtain the correlation signal.

Supplement 9. The method according to Supplement 8, wherein before performing an electrical average operation on the first product signal, the method further includes:
multiplying the first product signal with the low-frequency square wave to obtain a third product signal;
and determining correlation of the to-be-measured signal and the correlation signal by performing an electrical average operation on the first product signal includes:
determining correlation of the to-be-measured signal and the correlation signal by performing the electrical average operation on a product of the first product signal and the low-frequency square wave.

Supplement 10. An electronic device, including a memory and a processor, the memory storing a computer program, and the processor being configured to execute the computer program to implement a method for determining signal correlation according to any one of Supplements 1 to 9.

Supplement 11. A storage medium storing a computer readable program, wherein the computer readable program enables a computer to execute a method for determining signal correlation according to any one of Supplements 1 to 9, in an electronic device.

What is claimed is:

1. An apparatus for determining signal correlation, comprising:
a memory; and
a processor coupled to the memory to:
input a first signal to a first electro-optical conversion unit, to enable the first electro-optical conversion unit to modulate to-be-modulated light according to the first signal and to obtain a to-be-measured signal;
input a second signal to a second electro-optical conversion unit, to enable the second electro-optical conversion unit to modulate to-be-modulated light according to the second signal and to obtain a correlation signal;
determine a product signal of the to-be-measured signal and the correlation signal via a photoelectric method or an optical method; and
determine correlation of the to-be-measured signal and the correlation signal by performing an electrical average operation on the product signal.

2. The apparatus according to claim 1, wherein the first electro-optical conversion unit is a transmitter, or a partial modulation unit of a transmitter.

3. The apparatus according to claim 1, wherein the second electro-optical conversion unit outputs a finite number of states.

4. The apparatus according to claim 1, wherein the first electro-optical conversion unit and the second electro-optical conversion unit are connected in parallel;
the first electro-optical conversion unit outputs an optical signal of the to-be-measured signal, and the second electro-optical conversion unit outputs an optical signal of the correlation signal; and
the processor comprises a photoelectric multiplier, the photoelectric multiplier being used to:
perform photoelectric conversion and a multiplication operation on a sum of the optical signal of the to-be-measured signal and the optical signal of the correlation signal, to obtain the product signal.

5. The apparatus according to claim 4, wherein the first electro-optical conversion unit and the second electro-optical conversion unit are modulation units of different modulators; or
the first electro-optical conversion unit and the second electro-optical conversion unit are different modulation units of a same modulator.

6. The apparatus according to claim 1, wherein the first electro-optical conversion unit and the second electro-optical conversion unit are connected in series;
a product of an optical signal of the to-be-measured signal and an optical signal of the correlation signal is output after the first electro-optical conversion unit and the second electro-optical conversion unit are connected in series; and
the processor comprises a photoelectric conversion unit, the photoelectric conversion unit being used to:
perform photoelectric conversion on the product of the optical signal of the to-be-measured signal and the optical signal of the correlation signal, to obtain the product signal.

7. The apparatus according to claim 6, wherein the first electro-optical conversion unit and the second electro-optical conversion unit are modulation units of different modulators.

8. The apparatus according to claim 1, wherein the product signal is a first product signal the apparatus further comprises:
a multiplication unit, configured to multiply the second signal with a low-frequency square wave before the second signal is input to the second electro-optical conversion unit, to obtain a second product signal; and
the processor is further used to:
input the second product signal to the second electro-optical conversion unit, to enable the second electro-optical conversion unit to modulate to-be-modulated light according to the second product signal and to obtain the correlation signal.

9. The apparatus according to claim 8, wherein the multiplication unit is a first multiplication unit and the apparatus further comprises:
a second multiplication unit, configured to multiply the first product signal with the low-frequency square wave before an electrical average operation is performed on the first product signal, to obtain a third product signal; and
the processor is further used to:
determine correlation of the to-be-measured signal and the correlation signal by performing the electrical average operation on the third product signal obtained by multiplying the first product signal with the low-frequency square wave.

10. A method for determining signal correlation, comprising:
inputting a first signal to a first electro-optical conversion unit, to enable the first electro-optical conversion unit to modulate to-be-modulated light according to the first signal and to obtain a to-be-measured signal;
inputting a second signal to a second electro-optical conversion unit, to enable the second electro-optical conversion unit to modulate to-be-modulated light according to the input second signal and to obtain a correlation signal;
determining a product signal of the to-be-measured signal and the correlation signal via a photoelectric method or an optical method; and
determining correlation of the to-be-measured signal and the correlation signal by performing an electrical average operation on the product signal.
